(19) United States
(12) Patent Application Publication
(10) Pub. No.: US 2016/0205429 A1
(43) Pub. Date: Jul. 14, 2016

(54) MEDIA RESERVATION SYSTEM AND METHODS

(71) Applicants: Luis Miguel Ortiz, Albuquerque, NM (US); Luis M. Ortiz, Albuquerque, NM (US)

(72) Inventors: Luis Miguel Ortiz, Albuquerque, NM (US); Luis M. Ortiz, Albuquerque, NM (US)

(21) Appl. No.: 14/988,133

(22) Filed: Jan. 5, 2016

Related U.S. Application Data
(60) Provisional application No. 62/100,162, filed on Jan. 6, 2015.

(51) Int. Cl. H04N 21/422; H04N 21/4627; H04N 21/254; H04N 21/482; H04N 21/41

(52) U.S. Cl. CPC H04N 21/4222; H04N 21/482; H04N 21/4122; H04N 21/2541; H04N 21/4627

(57) ABSTRACT

Flat panel displays (e.g., Smart TVs) can wirelessly broadcast their identity for discovery to users of handheld devices (e.g., smartphones) interested selecting media data programming for display on a flat panel display selected from a plurality of flat panel displays. Data can include video, text, audio, and identifying information needed to access related data from a remote server. An application can be downloaded and activated on smartphones that will enable them to see a list of available (discovered) flat panel displays (multiple screens, depending on venue) and allow wireless access to flat panel displays and data associated with programming that can be displayed on the flat panel displays. A flat panel of interest can be selected by the smartphone and it can request that the flat panel render programming selected by the handheld device from a list of available programming.

### INVENTION PRIORITY

The present invention claims priority as a Continuation application of U.S. Provisional Patent Application Ser. No. 62/100,162 entitled “MEDIA RESERVATION SYSTEM AND METHODS,” filed Jan. 6, 2015, which is herein incorporated by reference in its entirety.

### FIELD OF THE INVENTION

The present invention is generally related to wireless handheld devices such as smartphones and also to data rendering devices such as flat panel displays, flat panel devices enabled as smart TVs, and media streaming devices connectable to flat panel displays for rendering data. The present invention is also related to the exchange of data between devices. More particularly, the present invention is related to methods and systems enabling the use of portable wireless handheld device such as smartphone to select a flat panel display from among a plurality of flat panel displays located throughout a venue to render video data also selected on the portable handheld device. The present invention is related to a media reservation system and methods for its use.

### BACKGROUND

Television sets today can be connected to data networks (e.g., the Internet) and are being marketed as “Smart TVs” because of their data network accessing capabilities, as well as the smartphone-like user interfaces they provide. Smart televisions and smartphones have only recently been able to interact with what is being referred to as “second screen” applications. Applications that are currently available are limited to the wireless rendering of data that is either provided from a smartphone for mirroring onto the screen of a flat panel display utilizing small gateway and video streaming devices such those provided by Apple (e.g., Apple TV's Airplay), Google (e.g., Chrome Cast and Nexus), Amazon Corporation (e.g., Fire), and Roku (e.g., Streaming Stick and Roku 3). Data associated with programming displayed on the flat panel display can be accessed from a remote server (i.e., website) after identifying a program being watched on a large flat panel display to the server by name or access code. Media sharing (e.g., mirroring) to flat panels directly from handhelds has also been enabled using other wireless means or standards such as DLNA via a router, and directly with flat panel devices using WIFI direct, which has been accomplished with applications such as Multiscreen Play (by Hisense), AllJoyn and Snapdragon (by Qualcomm), Content Share (by Haier), Miracast (by Panasonic), SmartShare (by LG), and others. Yet all of these applications are only described for use in sharing data from handheld devices to one flat panel display enabled with smartphone-initiated data rendering capabilities.

Flat panel televisions are now commonly deployed throughout sports bars, restaurants, lobbies, and other public venues. Oftentimes, a flat panel display will be playing media content that is not of interest to those located near the display. It is often the case that no one is paying attention to the video content being displayed; yet, it may be too much trouble to find a person working at the venue to change the programming. It is often the case in a large sports bar that several sports events are being displayed on several screens throughout the venue. A patron interested in football may be seated at the venue near screens that are not playing the live football game that the patron is interested in, so the patron must strain their eyes to focus on the football game playing on another screen located farther away (perhaps across the room) from where the patron is seated. At the same time, there may be a suitably located screen right near the patron that is playing a rerun of a tennis match or a pre-recorded fishing program. Worse, nobody located near the screen is paying attention to what is being displayed. The patron can ask the host, waiter, or manager to change the channel so that the live football game can be watched; but there is no other option other than moving to another table or continue watching the display screen located farther away.

An interesting data access problem presents itself in a scenario where there are several screens displaying multimedia data to spectators located in a public venue (e.g., a sports bar, sports stadium, casino sports book, etc.) rather than a private den or office. No solutions are currently available for spectators utilizing wireless handheld devices to access/select data associated with (or being rendered on) a first screen and selectively rendering the data for rendering on a second screen chosen from among several screens co-located at the same venue whereon various multimedia content is also being displayed. The present inventors believe that spectators/observers at a public venue would like the ability to access specific content being displayed on a first screen that is not conveniently located near them and move it (or select it) for rendering on a screen that is located closer to the spectators/observers, and/or otherwise to interact with what is being displayed on any of the multiple screens.

As of the priority filing date of this invention, there is no app or system available to allow a patron of a public venue to select programming on a flat panel display without requesting a venue employee to do so with a dedicated remote controller. What is needed is a system and method that enable public venue attendees, such as a sports bar patron, to use a smartphone to wirelessly select programming for display on a flat panel display that can also be selected wirelessly by the smartphone. What is needed is a media reservation system that can fulfill this need.

### SUMMARY

It is therefore a feature of the present invention to enable smartphone device users to select a first flat panel device from among a plurality of flat panel devices located throughout a venue to render data thereon that is also selected using the smartphone device (essentially moving video programming from a less convenient screen to a more convenient screen within a public venue such as a sports bar).

It is another feature of the present invention to enable a user of a smartphone to wirelessly engage with a media reservation system to select data and a desirable screen from among a plurality of programming content and screens that are available through the media reservation system to venue patrons.

It is another feature of the present invention to enable a plurality of flat panel devices located throughout a venue to broadcast their identities via wireless communications (e.g., Bluetooth or WiFi direct) to handheld devices used by patrons also located throughout the venue, a media reservation application that can be used by the handheld devices to select a flat panel display from the list of flat panel display, select media programming from a list of available media content that can be displayed on flat panel display located at the venue, and initiate media rendering based on the selections.

It is another feature of the present invention for the media reservation system to control all flat panel displays and all media programming, and to enable a patron to lock out subsequent patrons from changing programming being rendered on a selected flat panel display. The lockout period can last for a set period of time and require refreshing by the patron with the reservation, or can expire if the patron is not responsive to inquiries from the media reservation system.

It is another feature of the present invention for the media reservation system to enable other patrons to request transfer of control from a patron currently in control of a flat panel display. A text-like request can be displayed by the media reservation system on behalf of another patron to the patron that is currently controlling a screen. The request can be posed in the form of a question to which the patron in control must answer (e.g., “Do you want to continue controlling screen #10?” “Select ‘yes or ‘no.’” The patron can answer relinquish control of the screen to a subsequent patron, or can chose no. The reservation system can inquire another time if there is no answer, or if there is not answer within a set period of time, control can be relinquished automatically to the next patron on the reservation list.

It is another feature of the present invention to enable portable handheld devices to wirelessly discover, select, and obtain data/associated information from a select flat panel display. The operational features of the portable handheld device can be enabled with an App that can be downloaded from a server.

The media reservation system enables smartphone users to easily select a large screen from among several co-located screens and access the content being displayed on the large screen in the venue so that users can move and view the data on other large screens located throughout a venue.

In accordance with features of the preset invention, flat panel displays can be enabled to wirelessly broadcast their identity for discovery and can also identify data associated with the content being displayed to multiple users of handheld devices (e.g., smartphones). This capability can be referred to as mediacasting, or Mediacast-enabled with respect to aspects of the mediacasting capability directly incorporated into flat panel devices or can reside in a separate data rendering device connected to the flat panel devices. Data can include video, text, audio, and identifying information needed to access such data from a remote server. Handheld device users can activate an application on their smartphones that will enable them to see (discover) a list of available flat panel displays (often multiple screens, depending on venue) that allow wireless access by handheld devices and to a listing of data available for display on screens at the particular venue. The media reservation system can also enable smartphone users to select the screen of interest (or data for the screen of interest) and access additional data (either directly from the flat panel or from a remote server once the data has been identified) and/or engage in an interactive session in association with the displayed data.

In accordance with additional features of the present invention, possible venues that can deploy the mediacasting concept disclosed herein are: sports bars, sports venues, educational institutions, casino sports books, shopping centers, amusement parks, and the like.

In accordance with yet another feature of the present invention, an application (“APP”) that enables smartphones to interact with Mediacast-enabled flat panels can be downloaded from a server associated with application providers (e.g., Apple, Google Android, etc.).

Wireless standards that can be used to implement the invention include Bluetooth and WiFi direct.

Tablets and laptops could also be used to select screen and data for rendering in a venue under the teaching described herein.

### BRIEF DESCRIPTION OF THE FIGURES

FIG. 1 illustrates a system enabling flat panel discovery and access to data associated with programming displayed on a flat panel selected by a handheld device;

FIG. 2 illustrates a system enabling flat panel discovery, flat panel reservation and access to data associated with programming for display on a flat panel selected by a handheld device when several flat panel devices are also located in a venue near the handheld device;

FIG. 3 illustrates a system deployed in a large venue such as a sports stadium that utilizes wireless infrastructure at the venue to broadcast available data associated with programming being displayed on flat panel displays located throughout the large venue and can also enable access to the data associated with programming displayed on a particular flat panel (e.g., flat panels deployed in a private suite location) selected by a handheld device for displaying selected programming when several flat panel devices are also located near the handheld device in accordance with features of the present invention;

FIG. 4 illustrates a screen shot from a handheld device illustrating a list of flat panels wirelessly discovered for access to data therefrom;

FIG. 5 illustrates a screen shot from a handheld device illustrating a list of programming accessible for rendering on the flat panel selected by the handheld device to display the programming;

FIG. 6 illustrates a block diagram of steps that can be followed for discovering a flat panel and selecting media with a handheld device and selecting a flat panel and data in the form of video programming for display on the flat panel selected by the handheld device; and

FIG. 7 illustrates a block diagram of steps that can be followed for enabling discovery of a flat panel device by handheld devices and for providing data associated with programming displayed on the flat panel to the flat panel device selected from a list of available flat panel devices.

### DETAILED DESCRIPTION OF THE INVENTION

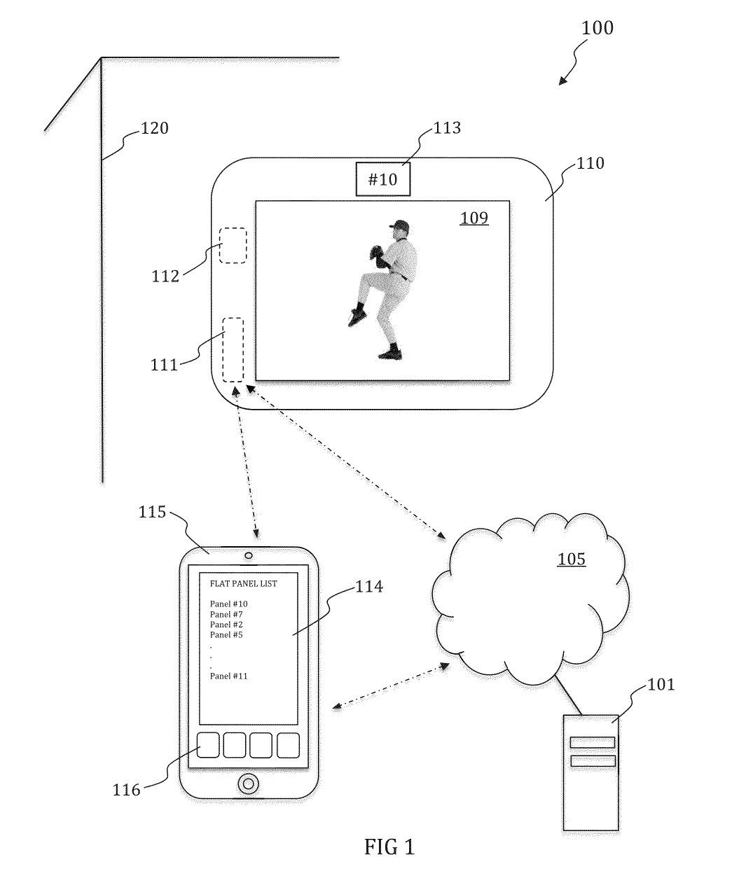

FIG. 1 illustrates a system 100 enabling flat panel discovery and access to data associated with programming displayed on a flat panel 110 selected by a handheld device 115. A flat panel 110 can have access to a data network 105 to retrieve programming and information from a remote server 101, either directly or via devices like Apple TV, Roku and set top boxes. The flat panel 110 can also have an internal (built-in) wireless communication module 111 (e.g., WiFi or Bluetooth™, or both) to support communications with nearby handheld devices 115 or to obtain further data access from the network 105 in the same manner as a connected device like Apple TV or Roku would through application software. The flat panel device can include a memory 112 that can function as a queue to store its identity and process select programming for display on a display screen (e.g., LCD, LED, Plasma, or the like) integrated in the flat panel, and which can include a limited amount of past programming previously displayed on the display screen 109 integrated in the flat panel. The wireless communication module can wirelessly broadcast identifying information 113 for the flat panel 101 to nearby handheld devices 115. The identifying information 113 can be an identification number (screen labeled #10, as shown) physically located on or near a flat panel 110 that can be read by spectators, electronic information broadcasted about the physical location of the flat panel 110 in a venue 120, and broadcasted information about programming being displayed on the flat panel 110. The broadcast of wireless-enabled device identities is common for WiFi hotspots and Bluetooth connected devices, where identifying information is periodically sent for receipt by devices in search of a wireless data connection; however, flat panel television sets do not currently broadcast identifying information (in particular, after-market labels, or physical location information), and information broadcasted from other devices today are not used for purposes of obtaining data associated with programming displayed on flat panel displays where numerous other flat panel displays may also be co-located (located next to each other) in a crowded venue (e.g., a sports bar, casino or sports stadium).

Flat panels 110 enabled with a wireless communication module 111 can be programmed using a media reservation system application to locate flat panel displays available for reservation and provide media for rendering on a selected flat panel display. Identifying information rather than just the manufacturer and model information can be broadcast by the flat panel. Manufacturer and model information would be useless if broadcasted from, for example, ten flat panel devices in a sports bar that are made by the same manufacturer and are the same model. This is why the use of unique identifying information can be necessary in accordance with features of the present invention. Information will be described in further detail below, but can include physical location, programming information or a name/label physically attached to the flat panel to assist users in identification of the desired flat panel to interact with.

The handheld device 115 can be provided in the form of a smartphone (e.g., iPhone, Android-based smartphone) or tablet and include an application 116 that enables the discovery of available flat panels 110 near the handheld device 115. Discovery can be accomplished by receiving identifying information 113 for the flat panel in a list of available devices 114. The flat panel 110 can be selected on the handheld device 115, and the handheld device 115 can then select the rendering of data associated with the selected programming for display at the flat panel 110. The handheld device 115 can also interact with programming displayed at the flat panel 110 via the application 116.

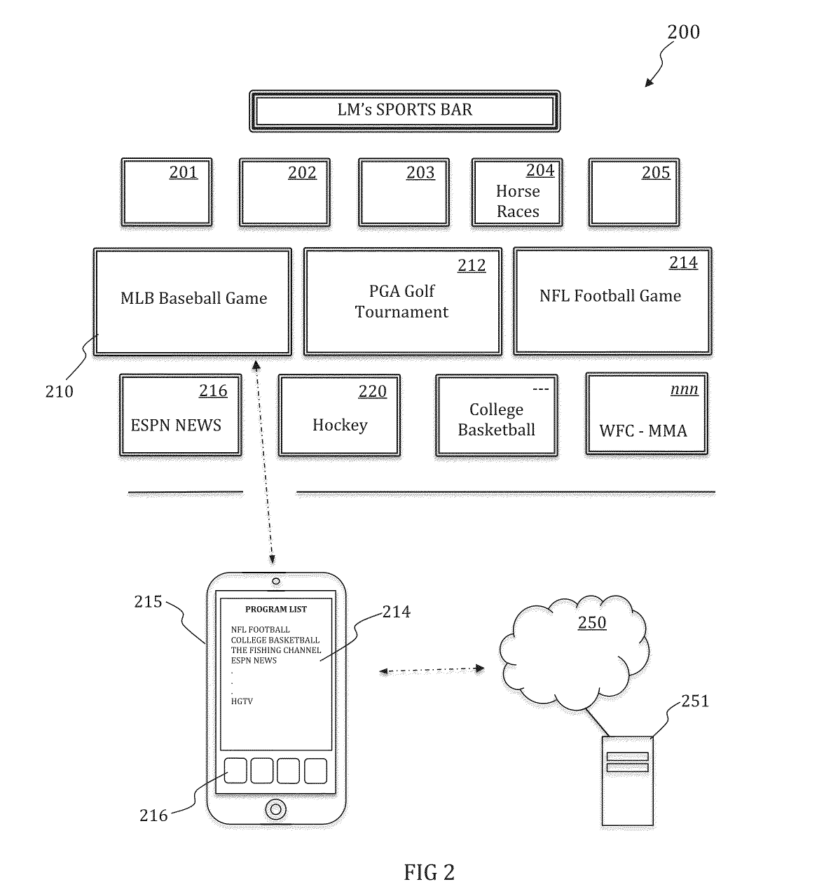

FIG. 2 illustrates a system 200 enabling a particular flat panel's discovery and access to data associated with programming displayed on a particular flat panel 210 selected by a handheld device 215 when several flat panel devices 201, 212, 216, . . . nnN are also located near the handheld device 215 and the flat panel 210 of interest. Such a scenario would be common in a publicly accessible venue, such as a sports bar or casino sports book where multiple flat panel displays rendering various programming are available. In this type of scenario, a Media reservation system application 216 can be opened on the handheld device 215 that will enable the handheld device 215 to locate the flat panel 210 of interest from among several flat panels that are also broadcasting their identities.

Identities can be determined numerically and based on content. Numerical identification can first be physical (e.g., by a user reading a number marked on the housing of a flat panel) and then electronic, based on information obtained physically. Identification can also be based on physical location information (e.g., “60 inch Sony-above cash register-over bar”). Identification can also be based on programming (e.g., “LA Lakers”, “Dodgers” or “HGTV”). It is entirely possible that the same programming of interest will be displayed on multiple flat panels located at the same venue. It this case, any of the flat panels 212 displaying the same programming of interest can be selected for data retrieval by, and/or interaction with, the handheld device 215. Once common programming information of interest is identified (i.e., the same football game, regardless of the flat panel used to identify it), the handheld device 215 can selectively retrieve or redirect programming related data from either the selected flat panel or a remote server 251 via a wireless data network for rendering on another flat panel.

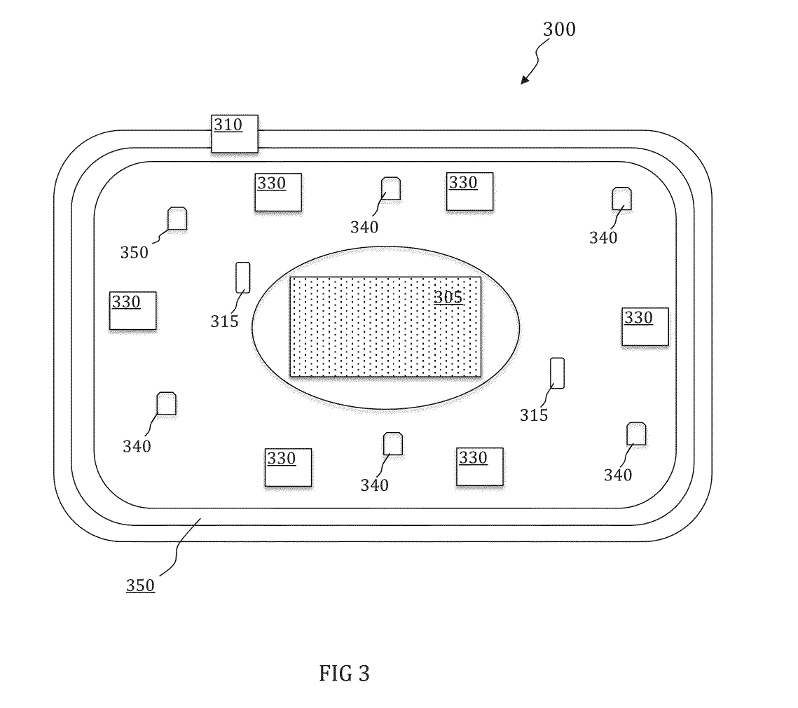

FIG. 3 illustrates a system 300 deployed in a large venue 350 such as a sports stadium that utilizes wireless infrastructure including hotspots 340 at the venue to broadcast available data associated with programming being displayed on flat panel displays 330 located throughout common areas of the large venue to handheld devices 315 also located at the venue 350, and can also enable access to the data associated with programming displayed on a particular flat panel 310 (e.g., flat panels deployed in a private suite location) selected by handheld devices 315 when several flat panel devices are also located near the handheld device in accordance with features of the present invention. Wireless infrastructure can include hotspots deployed throughout the large venue. U.S. Pat. No. 8,320,820 issued to Ortiz, co-inventor of the present invention, entitled “Self-contained data communication system nodes as stand-alone pods or embedded in concrete walkways and in walls at public venues including sports and entertainment venues” describes hotspots deployed in a sports venue to enable handheld device access to venue-related data. U.S. Pat. No. 8,320,820, which can be utilized to implement certain novel features of the present invention, is hereby incorporated by reference in its entirety for its teaching. The hotspot pods described by Ortiz can be adapted with media reservation system capabilities as described herein to provide handheld devices users with a list of data related to programming being displayed on flat panels in the venue that are available for selecting by the handheld devices to render selected data.

In accordance with features of the present invention, a system deployed in a sports stadium 350 can enable sports fans using smartphones 315 to interact with media being displayed at the venue to retrieve instant replays, statistics, and other data based on programming being viewed on numerous flat panel displays 330 typically located within such a venue 350. A football fan, for example, can select data available for rendering (e.g., an instant replay) and render it on a flat panel display 310 located near his seat. The invention benefits all sports (basketball, soccer, ice hockey, tennis) so long as flat panel displays 330 exist in the venue and are can display active programming to attendees. Programming information can also be used by the handheld device 315 to retrieve additional information from a remote server as previously described.

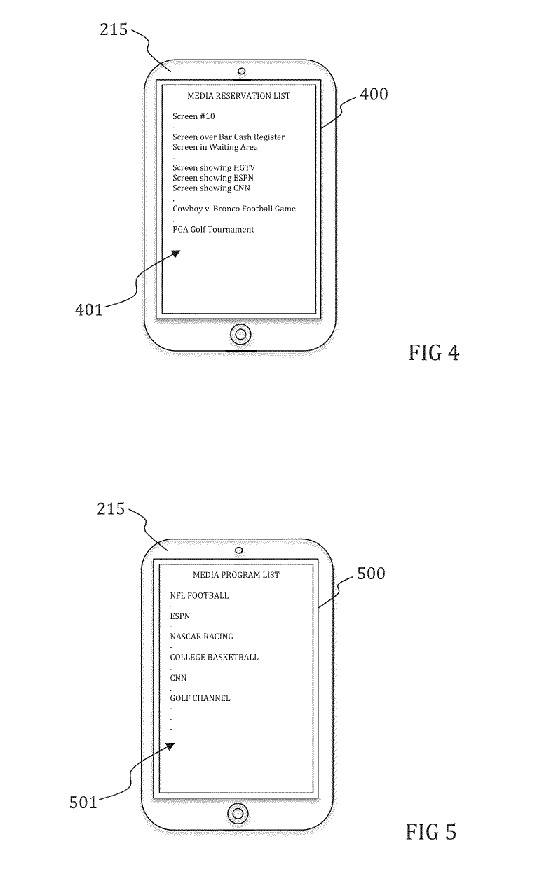

FIG. 4 illustrates a screen shot 400 from a handheld device 215 illustrating a menu-like list 401 of flat panels that were wirelessly discovered by the handheld device 215 for access and reservation to render media data also selected by the handheld device 215 for rendering thereon. A handheld device user can select a flat panel from a list based on the handheld device user's programming of interest. Once selected, the handheld device 215 will be engaged in a data retrieval and/or interaction session. Data can be retrieved based on real-time programming that is being displayed on a flat panel, or for programming that was recently displayed but has now passed (e.g., a commercial that has already passed, an instant replay of a live sports game, or statistical information about an athlete). Referring to FIG. 5, a screen shot 500 is shown from a handheld device 215 that can provide a list of programming 501 available for rendering on a selected flat panel that can still be selected and data rendered thereon by another handheld device user. This aspect of the invention is of high value in sports media where fast moving games can cause a sports fan to miss an important play or statistical information about an athlete or team that has already passed the screen. A user can be provided with limited access to past programming from a queue associated with the flat panel device, however, a menu of past programming as described with respect to FIG. 5 will simplify access to desired information by users. The listing can be provided in the form of show type or channel genre (e.g., “NFL Football”, “ESPN”, “HGTV”). Alternatively, the content can be displayed similarly to recorded video with a scroll bar that can include “pause”, “play”, “forward”, and “rewind” capabilities, similar to that provided for reviewing YouTube videos. The display of stored video content previously displayed by the flat panel and stored in the queue can also be enhanced with image tiles that pop up as the user moves along the scroll bar to help the user focus in on images for the video location that the user wants to review from the queue. Once the proper content is identified, the user can access data associated with the past programming/content.

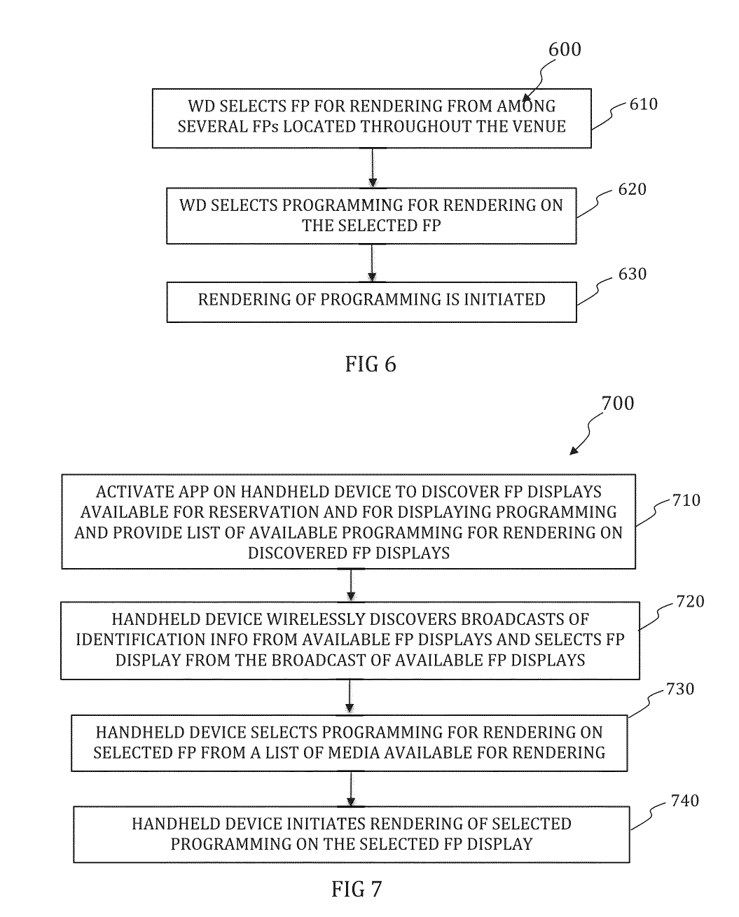

FIG. 6 illustrates a block diagram 600 of steps for discovering a flat panel with a handheld device and accessing data associated with programming available for display on the flat panels located at the venue. As shown in block 610, a flat panel displays programming on a display screen integrated in a flat panel display. In block 620, the flat panel wirelessly broadcasts its identification for wireless discovery by handheld devices. Then, at block 630 the handheld device provides selected programming information and access to data associated with the programming to a selected display screen.

FIG. 7 illustrates a block diagram 700 of steps enabling discovery of a flat panel device by handheld devices and for providing data associated with available programming for display of the programming on the flat panel selected by a handheld device. As shown in block 710, an application (media reservation system application) is activated on a handheld device to discover flat panel displays that can display programming on a display screen integrated in a flat panel display and enables a selected flat panel with access to data associated with the programming. The handheld device then wirelessly discovers broadcasts of identification information from the flat panel displays as shown in block 720. The handheld device is then used to select a flat panel display and obtains information associated with programming being displayed on the flat panel as shown in block 730. The information can include data (e.g., video, replay, etc.), but the handheld device can use information obtained from the flat panel to then access additional data associated with the programming being displayed on the selected flat panel display as shown in block 740.

It should be appreciated from the foregoing disclosure that the methods and systems described herein can be utilized in various environments including private offices or living rooms and public venues such as sports bars, casinos, sports stadiums, shopping centers, amusement parks, transportation terminals, educational institutions, and others.

1. A method enabling access to data associated with programming available for rendering on a flat panel display and selectable from a plurality of programming available from a media reservation system for display on flat panel displays located throughout a venue, comprising:
identifying a flat panel display available for data rendering within the venue and then wirelessly selecting the flat panel display using a wireless handheld device for rendering of programming data using the handheld device;
selecting programming data with the wireless handheld device for rendering on the flat panel display selected using the wireless handheld device; and
initiating rendering of the programming selected by the wireless handheld device on the flat panel display.

2. The method of claim 1, wherein the flat panel display is wirelessly discoverable by handheld devices by broadcasting an identification using wireless communications.

3. The method of claim 2, wherein the wireless data communications is at least one of Bluetooth and Wi-Fi data network communications.

4. The method of claim 1, wherein a media reservation system application is downloaded from a server to the wireless handheld device to provide programming on the wireless handheld device to facilitate flat panel discovery and programming selection.

5. The method of claim 1, wherein identification to available programming data available for rendering on flat panel displays is accessible from flat panel displays actively displaying programming throughout the venue.

6. The method of claim 2, wherein access to data associated with the programming is provided to handheld devices from a server over a data communications network.

7. The method of claim 1, wherein a request to take control over a flat panel display from a current user can be provided using wireless data messaging.

8. The method of claim 7, wherein control of a flat panel display can be relinquished by a current user to a requesting user if the current user does not respond to messaging or willingly agrees to relinquish control.

9. A system enabling wireless handheld device access to data associated with programming available for rendering on flat panel displays located throughout a venue, comprising:
a media reservation system provided in the form of at least one of a server or set top box and connected to a data network for access to data including video content and for receiving media reservations from wireless handheld devices;
more than one flat panel display in communication with the media reservation system and located within a venue and;
wireless data network access provided at the venue and providing communication to at least one of the more the one flat panel display, the media reservation system and wireless handheld devices;
wherein at least one of the media reservation system, at least one flat panel display of the more than one flat panel display, and the wireless handheld devices are programmed with a media reservation application to enable:
selection of an identified flat panel display using a wireless handheld device for rendering of programming data accessible through the media reservation system;
selection of programming data with the wireless handheld device from the media reservation system for rendering on the flat panel display selected by the wireless handheld device; and
rendering of the programming data selected by the wireless handheld device on the flat panel display.

10. The system of claim 9, wherein at least one flat panel display includes a wireless module and is wirelessly discoverable by handheld devices by broadcasting an identity using wireless data communications.

11. The system of claim 10, wherein the wireless module is at least one of Bluetooth and Wi-Fi data network communications module.

12. The system of claim 9, wherein a media reservation system application is downloaded from a server to provide programming on at least one of the media reservation system, the more than one flat panel display the handheld device to facilitate flat panel discovery and programming selection.

13. The system of claim 9, wherein identification of available programming data available for rendering of flat panel displays is accessible from flat panel displays actively displaying programming throughout the venue.

14. The system of claim 10, wherein access to data associated with the programming is provided to handheld devices from a server over a data communications network.

15. The system of claim 9, wherein a request to take control over a flat panel display from a current user can be provided using wireless data messaging.

16. The system of claim 15, wherein control of a flat panel display can be relinquished by a current user to a requesting user if the current user does not respond to messaging or willingly agrees to relinquish control.

17. A system enabling wireless handheld device access to data associated with programming available for rendering on flat panel displays located throughout a venue, comprising:
a media reservation module provided in at least one of a flat panel display, a server and set top box, said media reservation system providing access to multimedia data including video content via a data network and for receiving media reservations from wireless handheld devices, said media reservation module programmed to enable:
selection of an identified flat panel display using a wireless handheld device for rendering of programming data accessible through the media reservation system;
selection of programming data with the wireless handheld device via the media reservation system for rendering on the flat panel display selected by the wireless handheld device; and
initiating rendering of the programming data selected by the wireless handheld device on the flat panel display.

18. The system of claim 17, wherein access to data associated with the programming is provided to handheld devices from a server over a data communications network.

19. The system of claim 17, wherein the media reservation module enables a wireless handheld device to submit a request to take control over a flat panel display from a current user wherein the request can be provided using wireless data messaging.

20. The method of claim 19, wherein control of a flat panel display can be relinquished by a current user to a requesting user if the current user does not respond to messaging within a pre-determined period of time or willingly agrees to relinquish control via messaging.
